(19) United States
(12) Patent Application Publication
(10) Pub. No.: US 2014/0170489 A1
(43) Pub. Date: Jun. 19, 2014

(54) METHOD OF MANUFACTURING NEGATIVE ELECTRODE MATERIAL FOR LITHIUM ION SECONDARY BATTERY, AND NEGATIVE ELECTRODE MATERIAL FOR LITHIUM ION SECONDARY BATTERY

(71) Applicants: Hideaki Matsushima, Saitama (JP); Sakiko Tomonaga, Tokyo (JP)

(72) Inventors: Hideaki Matsushima, Saitama (JP); Sakiko Tomonaga, Tokyo (JP)

(73) Assignee: MITSUI MINING & SMELTING CO., LTD., Tokyo (JP)

(21) Appl. No.: 14/236,689

(22) PCT Filed: Aug. 3, 2012
(86) PCT No.: PCT/JP2012/069871

§ 371 Date: Feb. 3, 2014

(30) Foreign Application Priority Data
Aug. 4, 2011 (JP) 2011-171219

(51) Int. Cl. H01M 4/1395

(52) U.S. Cl. CPC H01M 4/1395
USPC 429/211; 427/77

(57) ABSTRACT

In manufacturing of a negative electrode material of a lithium ion secondary battery provided with a negative electrode mixture layer including a negative electrode active substance on a surface of a negative electrode current collector, one or mixture selected from granular materials alloyable with lithium and carbon materials for storing and releasing lithium is used as the negative electrode active substance; manufacturing method of a negative electrode material for a lithium ion secondary battery employed is characterized in that an electro-deposited copper foil in which a surface roughness (Ra) is 0.20 μm<Ra<0.50 μm and the surface roughness (Ra) satisfies [0.053×D₅₀(c)] μm to [0.210×D₅₀(c)] μm where (D₅₀(c)) is an average particle size of the negative electrode active substance is selectively used as the negative electrode current collector; a silane coupling agent treatment layer is provided on a surface of the electro-deposited copper foil.

### TECHNICAL FIELD

The present application relates to a method of manufacturing a negative electrode material for a lithium ion secondary battery, and a negative electrode material for a lithium ion secondary battery.

### BACKGROUND ART

In recent years, repeatedly usable lithium ion secondary batteries are popular as driving power sources of various types of electronic and electric devices and environment-friendly goods. Lithium ion secondary batteries are required a long-life in addition to a high charging/discharging capacity and a good performance in charging/discharging cycle. Then, various studies have been carried out and many inventions have been achieved under such purposes. Among these, a technology using a coupling agent on a surface of a metal foil used as a current collector has been broadly applied.

For example, Patent document 1 employs “an electrode for a nonaqueous electrolytic solution secondary battery characterized in that an active substance layer is provided on a current collector surface via a coupling agent layer on the surface of a current collector, and a method of manufacturing the same” for the purpose of providing an electrode for a nonaqueous electrolytic solution secondary battery excellent in adhesion between an active substance layer and a metal foil current collector.

Patent document 2 discloses “an electrode material for a lithium ion secondary battery in which a coupling agent-coated layer is provided on one surface or both surfaces of a metal foil; and an electrode in which a positive electrode mixture layer or a negative electrode mixture layer is provided on one surface or both surfaces of a metal foil through a coupling agent-coated layer” to provide an electrode material for a lithium ion secondary battery excellent in adhesion with a positive electrode mixture or a negative electrode mixture and not hinder conductivity and the electrode.

Patent document 3 discloses “a copper foil containing at least 0.018 wt % of carbon for an electrode of a secondary battery” which contributes to manufacture of a secondary battery in which the discharge capacity decline due to the expansion/contraction stress in charging/discharging is small; and the electrode breakage hardly occurs by using a copper foil in which the tensile strength is high and decline of the tensile strength in aging is small as an electrode material. Then, the preferable matter also disclosed is that “at least one surface of the copper foil is coated with a silane coupling agent”.

Patent document 4 discloses “an electrode for a lithium secondary battery in which an active substance thin film electrochemically or chemically stores and releases a lithium is provided on a current collector characterized in that a metal foil provided with a chromium-containing layer on the surface through chromate treatment is used as the current collector” to improve the charging/discharging cycle property by improving adhesion between a current collector and an active substance thin film in an electrode for a lithium secondary battery provided with an active substance thin film which electrochemically or chemically stores and releases lithium on the current collector. Further, the document cited 4 prefers surface treatment for coating a silane coupling agent after the chromate treatment.

### DOCUMENTS CITED

### Patent Document

[Patent document 1] Japanese Patent Laid-Open No. 09-237625
[Patent document 2] Japanese Patent Laid-Open No. 09-306472
[Patent document 3] Japanese Patent Laid-Open No. 10-21928
[Patent document 4] Japanese Patent Laid-Open No. 2002-319407

### SUMMARY OF THE INVENTION

### Problems to be Solved

However, although employment of technologies disclosed in the above-mentioned patent documents has achieved certain effects in the high charging/discharging capacity and the good charging/discharging cycle property in lithium ion secondary batteries, a further high performance has been demanded.

### Means to Solve the Problem

Then, as a result of intensive studies of the present inventors, it has been made apparent that the concept described later can secure a good charging/discharging cycle property in addition to a high charging/discharging capacity of a lithium ion secondary battery, and the long-life lithium ion secondary battery can be achieved.

Technical concept of the present invention pays attention to “a relation between surface roughness (Ra) of a negative electrode current collector and an average particle size (D₅₀(c)) of the negative electrode active substance” to stably achieve excellent charging/discharging capacity and charging/discharging cycle property with minimal deviation. Then, the matters have been made apparent that combination of the technical concept and provision of a silane coupling agent treatment layer on a metal foil for a negative electrode current collector enables design of a high-quality negative electrode current collector for a lithium ion secondary battery. Hereinafter, the outline of the invention will be described.

Manufacturing method of a negative electrode material for a lithium ion secondary battery: Manufacturing method of a negative electrode material for a lithium ion secondary battery according to the present application is the manufacturing method of the negative electrode material for a lithium ion secondary battery provided with a negative electrode mixture layer including a negative electrode active substance comprising one or mixture selected from granular materials alloyable with lithium and carbon materials for storing and releasing lithium is used as the negative electrode active substance; characterized in that an electro-deposited copper foil in which a surface roughness (Ra) is 0.20 μm<Ra<0.50 μm and the surface roughness (Ra) satisfies [0.053×D₅₀(c)] μm to [0.210×D₅₀(c)] μm where (D₅₀(c)) is an average particle size of the negative electrode active substance is selectively used as the negative electrode current collector; a silane coupling agent treatment layer is provided on a surface of the electro-deposited copper foil; and the negative electrode material is finished by providing the negative electrode active substance on a surface of the silane coupling agent treatment.

In the manufacturing method of a negative electrode material for a lithium ion secondary battery according to the present application, the electro-deposited copper foil is preferable to have a roughened surface with fine metal particles attached having an average particle size (D(p)) of [0.06×D₅₀ (c)] μm to [0.44×D₅₀(c)] μm where (D₅₀(c)) is an average particle size of the negative electrode active substance on one surface or both surfaces of the copper foil. D(p) is an average particle size among 30 or more particles in a scanning electron microscope image suitably employing a magnification which enables measurement of a primary particle size.

In the manufacturing method of a negative electrode material for a lithium ion secondary battery according to the present application, the electro-deposited copper foil is preferable to have a roughened surface with fine metal particles attached composed of any one selected from copper, a copper alloy, nickel, a nickel alloy, cobalt and a cobalt alloy.

In the manufacturing method of a negative electrode material for a lithium ion secondary battery according to the present application, the average particle size (D₅₀(c)) of the negative electrode active substance is preferable to be 2.0 μm to 4.0 μm.

In the manufacturing method of a negative electrode material for a lithium ion secondary battery according to the present application, the negative electrode active substance is preferable to include tin or silicon as a material alloyable with lithium.

Negative electrode material for a lithium ion secondary battery: A negative electrode material for a lithium ion secondary battery according to the present application is manufactured by any of the manufacturing method of a negative electrode material for a lithium ion secondary battery described above.

### Advantages of the Invention

As the technical concept according to the present application of “a relation between a negative electrode current collector surface roughness (Ra) and an average particle size (D₅₀(c)) of the negative electrode active substance” described above is employed, the charging/discharging capacity and the good charging/discharging cycle property can be stably achieved with minimal deviation. Then, as the technical concept of the present application is combined with a silane coupling agent treatment layer provided on a metal foil as a negative electrode current collector, the effect of the silane coupling agent is made maximum to enable design of a high-quality negative electrode current collector for a lithium ion secondary battery.

### Preferred Embodiment of the Invention

Hereinafter, embodiments of manufacturing method of negative electrode materials for a lithium ion secondary battery; and negative electrode materials for a lithium ion secondary battery manufactured by the manufacturing method according to the present application will be described.

Manufacturing method of a negative electrode material for a lithium ion secondary battery: Manufacturing method of a negative electrode material for a lithium ion secondary battery according to the present application is the manufacturing method of the negative electrode material for a lithium ion secondary battery provided with a negative electrode mixture layer including a negative electrode active substance comprising one or mixture selected from granular materials alloyable with lithium and carbon materials for storing and releasing lithium is used as the negative electrode active substance; characterized in that an electro-deposited copper foil in which a surface roughness (Ra) is 0.20 μm<Ra<0.50 μm and the surface roughness (Ra) satisfies [0.053×D₅₀(c)] μm to [0.210×D₅₀(c)] μm where (D₅₀(c)) is an average particle size of the negative electrode active substance is selectively used as the negative electrode current collector; a silane coupling agent treatment layer is provided on a surface of the electro-deposited copper foil; and the negative electrode material is finished by providing the negative electrode active substance on a surface of the silane coupling agent treatment layer. That is, the manufacturing method realizes the technical concept in which a negative electrode material is designed by paying attention to “a relation between a negative electrode current collector surface roughness (Ra) and an average particle size (D₅₀(c)) of the negative electrode active substance.” Hereinafter, the method will be demonstrated.

In the manufacturing method of a negative electrode material for a lithium ion secondary battery according to the present application, the electro-deposited copper foil is preferable to have a roughened surface with fine metal particles attached having an average particle size (D(p)) of [0.06×D₅₀(c)] vim to [0.44×D₅₀(c)] μm where (D₅₀(c)) is an average particle size of the negative electrode active substance on one surface or both surfaces of the copper foil. The surface roughness (Ra) of a negative electrode current collector of less than [0.053×D₅₀(c)] μm is not preferable since adhesion of a negative electrode active substance of D₅₀(c) in average particle size to the surface of the negative electrode current collector decreases, and particles of the negative electrode active substance tend to fall off from the current collector surface in expansion/contraction of the negative electrode material due to charging/discharging to result a inferior lithium ion secondary battery in quality. In contrast, the surface roughness (Ra) of a negative electrode current collector exceeding [0.210×D₅₀(c)] μm is not preferable for a long-life lithium ion secondary battery since particles of a negative electrode active substance excessively penetrate into irregularities on the surface of the negative electrode current collector, and a notch effect appears on the bottom surface of the valleys of the irregularities in the repeating expansion/contraction due to charging/discharging generates microcracks in the negative current collector to results breakage. Further, less uniformity in the thickness of a negative electrode active substance layer makes the distance between a positive electrode and a negative electrode locationally deviate to cause a nonuniform charging/discharging reaction and locally deteriorated negative electrode active substance decrease the battery life of a lithium ion secondary battery.

More specifically, if the average particle size (D₅₀(c)) of a negative electrode active substance is 2.0 μm to 4.0 μm, it is preferable to selectively use an electro-deposited copper foil whose surface roughness (Ra) of the negative electrode current collector is 0.20 μm<Ra<0.50 μm. With the range of the surface roughness, even if expansion/contraction of a negative electrode material occurs in charging/discharging, particles of the negative electrode active substance are hard to fall off from the surface of the electro-deposited copper foil used as a negative electrode current collector.

As a copper foil used for a negative electrode current collector, an electro-deposited copper foil is preferable. This is because an electro-deposited copper foil enables selective use of a copper foil having higher softening resistance in the manufacturing process of a negative electrode material if compared to a rolled copper foil. Particularly VLP (R) copper foil manufactured by Mitsui Mining & Smelting Co., Ltd., an electro-deposited copper foil having a softening temperature of 300° C. or more is preferably used. The thickness of an electro-deposited copper foil is not especially limited, but an electro-deposited copper foil of 6 μm to 70 μm is preferable. The thickness of an electro-deposited copper foil of less than 6 μm does not satisfy the deformation resistance required in expansion/contraction of a negative electrode material in charging/discharging of a lithium ion secondary battery and not achieve long-life of the lithium ion secondary battery. In contrast, although the thickness of an electro-deposited copper foil exceeding 70 μm may not cause specific problem, such electro-deposited copper foil is not preferable since the thickness is not suitable for a higher capacity per unit volume required for miniaturization of batteries in recent years.

In manufacturing method of a negative electrode material for a lithium ion secondary battery according to the present application, the electro-deposited copper foil is preferable to have a roughened surface in which fine metal particles having an average particle size (D(p)) of [0.06×D₅₀(c)] μm to [0.44×D₅₀(c)] μm where (D₅₀(c)) is the average particle size of the negative electrode active substance are attached on one surface or both surfaces of the copper foil. That is, the electro-deposited copper foil is roughened on at least one surface as the words “on one surface or both surfaces of the copper foil” are described. A method of roughening a surface of an electro-deposited copper foil can optionally be selected from various methods including attaching of metal particles and chemical etching of the surface. However, the method for attaching metal particles is preferable to deposite the metal particles as optional components on the surface of an electro-deposited copper foil by employing a plating method because the plating method can select various metal components and roughness control is easy.

The fine metal particles are preferable to be composed of any components of copper, a copper alloy, nickel, a nickel alloy, cobalt and a cobalt alloy. If the fine metal particles are formed of copper, stable adhesion between the fine copper particles and the electro-deposited copper foil surface is easily achieved since an electro-deposited copper foil is also copper. Fine metal particles formed of a copper alloy usable include copper-zinc alloys, copper-nickel alloys, copper-nickel-silicon alloys, copper-chromium alloys, copper-chromium-zirconium alloys having expectable properties including heat resistance, corrosion resistance and high mechanical strength exceeding copper. Among these, as nickel, nickel alloys, cobalt and cobalt alloys are excellent in heat resistance, fine metal particles formed of these components are preferable because of excellent softening resistance for heating in the manufacturing process of a negative electrode material.

To attach the fine metal particles on a surface of an electro-deposited copper foil, the following method is preferable to be employed. A plating solution having a composition capable of providing fine metal particles of an objective component is prepared at first. An electro-deposited copper foil is cathodically polarized under a burnt plating condition in the plating solution to deposite the fine metal particles on a surface of the electro-deposited copper foil. Further, the electro-deposited copper foil is cathodically polarized under a level plating condition immediately to fix the fine metal particles on the electro-deposited copper foil surface to prevent the fine metal particles attached on the electro-deposited copper foil surface from falling-off.

If fine metal particles having an average particle size (D(p)) of less than [0.06×D₅₀(c)] μm are attached on one surface or both surfaces of the electro-deposited copper foil, adhesion between an active substance and a surface of a current collector cannot sufficiently be secured since the roughness of the roughened surface is excessively small and fails to make the life of the lithium ion secondary battery long. In contrast, if fine metal particles having an average particle size (D(p)) of exceeding [0.44×D₅₀(c)] μm are attached, the deformation resistance of a negative electrode material required in expansion/contraction of the negative electrode material in charging/discharging of a lithium ion secondary battery may be low since the roughness of a roughened surface is excessively large and fails to make the life of the lithium ion secondary battery long.

More specifically, if the average particle size (D₅₀(c)) of a negative electrode active substance is 2.0 μm to 4.0 μm, fine metal particles having an average particle size (D(p)) of 0.12 μm to 1.76 μm are preferable to be attached on one surface or both surfaces of the electro-deposited copper foil. So, if the average particle size (D₅₀(c)) of a negative electrode active substance is 2.6 μm, fine metal particles having an average particle size of 0.16 μm to 1.14 μm are preferable to be attached. The results of investigation on the property with further extended average particle size of the fine metal particles are shown in Table 1. Table 1 shows the dependency of “the capacity maintenance rate (vs. LMO) after 50 cycles” on the particle size of fine metal particles attached on one surface of an electro-deposited copper foil. According to the results shown in Table 1, the capacity maintenance rate of 70% or more is specified as determination criteria for the property required.

TABLE 1

| | Relation between | | | |
|---|---|---|---|---|
| Average | Average Particle | | | |
| Particle | size (D₅₀(c)) of | | Capacity | |
| size of Fine | Active Substance | | Maintenance | |
| Metal | and D(p) | | rate (vs. | |
| Particles | | D(p)/ | LMO) after | |
| (D(p)) | D₅₀(c) | D₅₀(c) | 50 Cycles | Determination |
| 0.25 | 2.0 | 0.13 | 85 | Good |
| | 2.6 | 0.10 | 86 | Good |
| | 4.0 | 0.06 | 70 | Acceptable |
| 0.70 | 2.0 | 0.35 | 78 | Acceptable |
| | 2.6 | 0.27 | 88 | Good |
| | 4.0 | 0.18 | 80 | Acceptable |
| 0.88 | 2.0 | 0.44 | 74 | Acceptable |
| | 2.6 | 0.34 | 86 | Good |
| | 4.0 | 0.22 | 85 | Good |
| 1.30 | 2.0 | 0.65 | 53 | Not Good |
| | 2.6 | 0.50 | 66 | Not Good |
| | 4.0 | 0.33 | 73 | Acceptable |
| Reference | 2.0 | 0 | 73 | Acceptable |
| Without | 2.6 | 0 | 74 | Acceptable |
| Roughening | 4.0 | 0 | 64 | Not Good |
| Treatment | | | | |
| Ra = 0.19 | | | | |

Determination Criteria:
capacity maintenance rate after 50 cycles of 85% or more is “Good”
capacity maintenance rate after 50 cycles of 70% to less than 85% is “Acceptable”
capacity maintenance rate after 50 cycles of less than 69% is “Not Good”

As is apparent in Table 1, if the average particle size (D₅₀(c)) of negative electrode active substances is 2.6 μm, “the capacity maintenance rates (vs. LMO) after 50 cycles” exceeds 70% with the average particle sizes of the fine metal particles used in the roughening treatment of in the suitable range (0.16 μm to 1.14 μm). However, if an average particle size is 1.30 μm, out of the suitable particle size range of the fine metal particle, “the capacity maintenance rate (vs. LMO) after 50 cycles” is less than 70%. So, the matter is made apparent that if the average particle size (D(p)) is [0.06×D₅₀(c)] μm to [0.44×D₅₀ (c)] μm, the quality as a negative electrode current collector is stable.

After finishing roughening treatment, the surface of the electro-deposited copper foil may be subjected to various types of rust-proofing treatments. In the rust-proofing treatment, rust-proofing treatment layers including an organic layer using an organic agent such as imidazole or benzotriazole and an inorganic layer using a zinc or zinc alloy layer or a chromate treatment layer may be provided. In consideration as a rust-proofing treatment of a negative electrode current collector for a lithium ion secondary battery, selective use of a zinc alloy rust-proofing layer such as a zinc-nickel alloy layer or a zinc-nickel-cobalt alloy layer is preferable. As the components constituting the rust-proofing treatment layer are soft and excellent in stretch-ability, the components hardly trigger off microcracks in expansion/contraction due to charging/discharging and results improved tearing resistance. Depending on applications, it is preferable to further provide an electrolytic chromate treatment layer on the zinc alloy rust-proofing layer. The rust-proofing property is further improved.

The electro-deposited copper foil used in manufacturing of a negative electrode material of a lithium ion secondary battery is provided with a silane coupling agent treatment layer adsorbed on at least one surface. A silane coupling agent treatment layer improves adhesion between a negative electrode current collector and a negative electrode active substance. Further, falling-off of particles of a negative electrode active substance from the surface of the electro-deposited copper foil used as a negative electrode current collector is further prevented if charging/discharging causes expansion/contraction of a negative electrode material.

In the providing of a silane coupling agent treatment layer on a surface of an electro-deposited copper foil, the following method may be employed. The kind of the silane coupling agent is not especially limited, and a silane coupling agent suitably corresponds to the kind of a negative electrode active substance can be selectively used. Silane coupling agents usable for formation of a silane coupling agent treatment layer include epoxy-silane coupling agents, amino-silane coupling agents, and mercapto-silane coupling agents. A silane coupling agent solution having concentration of 1 g/L to 8 g/L is prepared by putting a silane coupling agents in a solvent such as water, a mixed solvent of water and an organic solvent or an organic solvent. Then, the silane coupling agent solution is made contact with a surface of an electro-deposited copper foil by a methods including a dropping method, a showering method, a spraying method and an immersion method followed by drying to provide a silane coupling agent treatment layer on the electro-deposited copper foil surface.

In the manufacturing method of a negative electrode material for a lithium ion secondary battery according to the present invention, a negative electrode active substance contains one or mixture selected from granular materials alloyable with lithium and carbon materials which stores and releases lithium. The granular material alloyable with lithium is preferable to contain one or mixture selected from boron, aluminum, gallium, indium, silicon, germanium, tin, lead, zinc and silver. Specifically, it is preferable to contain “silicon” or “tin” having a larger theoretical capacity than carbon materials which have conventionally been used as negative electrode active substances. A higher charging/discharging capacity and a good charging/discharging cycle property as a lithium ion secondary battery can be achieved.

A negative electrode material for a lithium ion secondary battery: A negative electrode material for a lithium ion secondary battery according to the present application is manufactured by any of the methods of manufacturing a negative electrode material for a lithium ion secondary battery described above. A negative electrode material for a lithium ion secondary battery manufactured by the above-mentioned method of manufacturing a negative electrode material has both a good charging/discharging capacity and a good charging/discharging cycle property and less deviation in these properties. Therefore, a long-life and high-quality lithium ion secondary battery can be manufactured. The matter should be clearly noted that there is no limitation in the shape including flat plate shape, circular shape and spiral shape, the size and the thickness of a negative electrode material as the negative electrode material for a lithium ion secondary battery.

### EXAMPLE 1

Preparation of an electro-deposited copper foil: In the present Example 1, an electro-deposited copper foil A used as a copper foil for a lithium ion secondary battery negative electrode current collector was manufactured as follows. The untreated electro-deposited copper foil (thickness: 12 μm) used for preparation of the electro-deposited copper foil A was manufactured by using a popular electro-deposited copper foil manufacturing apparatus equipped a rotating cathode and a copper electrolytic solution having a copper concentration of 80 g/L, a sulfuric acid concentration of 250 g/L, a chlorine concentration of 2.7 ppm and a gelatin concentration of 2 ppm, and a solution temperature of 50° C., and electrolysis was carried out at a current density of 60 A/dm². The surface roughness (Ra) of the untreated electro-deposited copper foil is 0.19 μm at the cathode side and 0.31 μm at the deposit side. In the present Example 1, a contact type surface roughness tester (trade name: SE-3500) produced by Kosaka Laboratory Ltd was used for the measurement of the surface roughness (Ra). Hereinafter, the same method was carried out in the all measurement of the surface roughness (Ra).

Next, the cathode side of the untreated electro-deposited copper foil was subjected to a roughening treatment. The roughening treatment employed a burnt plating condition using a copper electrolytic solution having a copper concentration of 8 g/L, a sulfuric acid concentration of 200 g/L and a solution temperature of 35° C. with a current density of 25 A/dm² for depositing fine copper particles on the cathode side of the untreated electro-deposited copper foil. Further, a level plating was carried out to prevent falling-off of the fine copper particles deposited on the cathode side of the untreated electro-deposited copper foil with a level plating condition using a copper electrolytic solution of a copper concentration of 70 g/L, a sulfuric acid concentration of 110 g/L and a solution temperature of 50° C. with a current density of 25 A/dm² to finish a roughened surface. Average particle size of the fine copper particles is 0.25 μm.

Then, a zinc-nickel alloy layer as a rust-proofing treatment was provided on the roughened surface. The zinc-nickel alloy layer was provided by using a zinc-nickel alloy plating solution containing nickel sulfate of 1 g/L, zinc pyrophosphate of 1.5 g/L and potassium pyrophosphate of 80 g/L and a solution temperature of 40° C. and pH of 10 with the electrolysis condition, a current density of 0.5 A/dm².

A chromate treatment layer as a rust-proofing treatment layer was further provided on a surface of the zinc-nickel alloy layer. An electrolytic chromate treatment method was employed for the formation of the chromate treatment layer, a chromate solution of chromium concentration of 3.6 g/L, pH of 12.5 and a solution temperature of 40° C. was used, and electrolyzed for 1.5 sec with a current density of 2.37 A/dm². Then, the electro-deposited copper foil after finishing the chromate treatment was rinsed with water. As described above, the rust-proofing treatment layer composed of the zinc-nickel alloy layer and the chromate treatment layer was provided on the roughened surface.

After finishing the rust-proofing treatments, a silane coupling agent treatment was carried out on the electro-deposited copper foil. In the present Example 1, a silane coupling agent treatment layer was provided to obtain an electro-deposited copper foil A through contacting a silane coupling agent-containing aqueous solution containing “3-aminopropyltrimethoxysilane” of 5 g/L as a silane coupling agent on the rust-proofing treatment layer at the roughened surface of the electro-deposited copper foil by a showering method followed by drying. The surface roughness (Ra) of the roughened surface of the electro-deposited copper foil A is 0.21 μm.

Preparation of active substance particles: Three grade of active substance particles in Example 1, “a silicon powder 1 having an average particle size (D₅₀(c)) of 2.0 μm”, “a silicon powder 2 having an average particle size (D₅₀(c)) of 2.6 μm” and “a silicon powder 3 having an average particle size (D₅₀(c)) of 4.0 μm” were prepared by crushing a silicon ingot by a jet mill followed by sieving the crushed silicon powder. The average particle size (D₅₀(c)) of the silicon particles was measured by using a MicroTrack particle size distribution analyzer (No. 9320-X100) manufactured by Nikkiso Co., Ltd. In Examples 2 to 4 and Comparative Examples 1 to 3, the same silicon powders as in Example 1 were used as active substance particles.

Manufacturing of negative electrode materials: In Example 1, a negative electrode material was manufactured by using the electro-deposited copper foil A as follows. First, a negative electrode mixture containing a negative electrode active substance, a conductive material and a binder was prepared for formation of a negative electrode mixture layer. The negative electrode mixture (slurry) was prepared by using the silicon powder 1, acetylene black as a conductive material, polyamic acid as a binder and NMP (N-methylpyrrolidone) as a solvent, and mixing these in a mass ratio of 100:5:15:184.

Then, the negative electrode mixture was applied on the roughened surface of the electro-deposited copper foil A by using an applicator, and dried at 200° C. for 2 hours to evaporate the solvent. Then, an annealing treatment at 350° C. for 1 hour was carried out for dehydrating condensation reaction of polyamic acid to finish a negative electrode material Example 1-I. A negative electrode material Example 1-II was manufactured by the same procedure using the silicon powder 2 in place of the silicon powder 1 as a negative electrode active substance. A negative electrode material Example 1-III was manufactured by the same procedure by using the silicon powder 3 in place of the silicon powder 1 as a negative electrode active substance.

### EXAMPLE 2

In Example 2, an electro-deposited copper foil B in which the same rust-proofing treatment layer and silane coupling agent treatment layer as in Example 1 was provided on the deposit surface of the untreated electro-deposited copper foil used in manufacturing of the electro-deposited copper foil A in Example 1 was used. Then, negative electrode material Examples 2-I, 2-II and 2-III were manufactured by providing respective negative electrode mixture layers using the silicon powders 1 to 3 respectively as a negative electrode active substance on the deposit side of the electro-deposited copper foil B by the same procedure as in Example 1.

### EXAMPLE 3

In Example 3, an electro-deposited copper foil C was manufactured by the same method as the manufacturing method of the electro-deposited copper foil in Example 1 except that the time for depositing fine copper particles was changed in the roughening treatment. The average particle size of the fine copper particles is 0.70 μm. The surface roughness (Ra) of the roughened surface of the electro-deposited copper foil C is 0.32 Then, negative electrode material Examples 3-I, 3-II and 3-III were manufactured by providing respective negative electrode mixture layers using the silicon powders 1 to 3 respectively as a negative electrode active substance on the roughened surface of the electro-deposited copper foil C by the same procedure as in Example 1.

### EXAMPLE 4

In Example 4, an electro-deposited copper foil D was manufactured by the same method as the manufacturing method of the electro-deposited copper foil in Example 1 except that the time for depositing fine copper particles was changed in the roughening treatment. The average particle size of the fine copper particles is 0.88 μm. The surface roughness (Ra) of the roughened surface of the electro-deposited copper foil D is 0.42 μm. Then, negative electrode material Examples 4-I, 4-II and 4-III were manufactured by providing respective negative electrode mixture layers using the silicon powders 1 to 3 respectively as a negative electrode active substance on the roughened surface of the electro-deposited copper foil D by the same procedure as in Example 1.

### COMPARATIVE EXAMPLES

### Comparative Example 1

In Comparative Example 1, an electro-deposited copper foil E used was the electro-deposited copper foil A used in Example 1 without just roughening treatment. Then, negative electrode material Comparative Examples 5-I, 5-II and 5-III were manufactured by providing respective negative electrode mixture layers using the silicon powders 1 to 3 respectively as a negative electrode active substance on the cathode side of the electro-deposited copper foil E whose surface roughness (Ra) is less than the lower limit value, by the same procedure as in Example 1.

### Comparative Example 2

In Comparative Example 2, an electro-deposited copper foil F whose surface roughness (Ra) exceeds the upper limit was manufactured by changing the time for both depositing fine copper particles and level plating in the roughening treatment on the deposit side of the untreated electro-deposited copper foil by the same manufacturing method of the electro-deposited copper foil as in Example 1. The surface roughness (Ra) of the roughened surface of the electro-deposited copper foil F is 0.60 μm. The average particle size of the fine copper particles is 1.30 μm. Then, negative electrode material Comparative Examples 6-I, 6-II and 6-III were manufactured by providing respective negative electrode mixture layers using the silicon powders 1 to 3 respectively as a negative electrode active substance on the roughened surface of the electro-deposited copper foil F by the same procedure as in Example 1.

### Comparative Example 3

Comparative Example 3 was manufactured for verifying the influence of the presence and absence of a silane coupling agent treatment in an electro-deposited copper foil used in manufacturing of a negative electrode of a lithium ion secondary battery. An electro-deposited copper foil G without silane coupling agent treatment after the rust-proofing treatment in Example 1 was manufactured. The surface roughness (Ra) of the roughened surface is 0.21 and the average particle size of the fine copper particles is 0.25 μm. Then, negative electrode material Comparative Examples 6-I, 6-II and 6-III were manufactured by providing respective negative electrode mixture layers using the silicon powders 1 to 3 respectively as a negative electrode active substance on the roughened surface of the electro-deposited copper foil G by the same procedure as in Example 1.

### [Evaluation of Properties]

Synthetic Performance: Measurement results on “the first cycle charging/discharging efficiency (vs. Li)” and “the capacity maintenance rate (vs. LMO) after 50 cycles” as a lithium ion secondary battery was set as an index and the synthetic performance as the lithium ion secondary battery was determined in four levels of “Excellent”, “Good”, “Acceptable” and “Not Good”. Wherein, performance level of good negative electrode materials in a lithium ion secondary battery without practical trouble includes Acceptable to Excellent.

First cycle charging/discharging efficiency (vs. Li): First cycle charging/discharging efficiency (vs. Li) is evaluation of the reversibility in the first charging/discharging cycle of a half cell. To evaluate the reversibility in the first charging/discharging cycle, a half cell was manufactured by using each of the negative electrode material Examples 1-I to 4-III and the negative electrode material Comparative Examples 5-I to 7-III as a test electrode, and a lithium metal electrode was used as a counter electrode for the each test electrode. As an electrolytic solution, a solution dissolved LiPF₆ in 1 mol/L into a mixed solvent consist of ethylene carbonate and diethyl carbonate in 1:1 in volume and externally added vinylidene carbonate in 2% by volume was used. As a separator, a porous polypropylene film of 20 μm-thick was used.

The half cell was charged under a constant current (CC) condition at a charging rate of 0.05 C until the end voltage reach to 0.001 V (vs. Li/Li⁺) in the first cycle charging, followed by charging under a constant voltage (CV) condition until the current reach to 0.01 C. In the first cycle discharging, the half cell was discharged under a constant current (CC) condition at discharging rate of 0.05 C until an end voltage reach to 1.5 V. The ratio of a first discharge capacity to a charge capacity in the first charging/discharging cycle was evaluated a first cycle charging/discharging efficiency, the reversibility of charging/discharging.

Capacity maintenance rate (vs. LMO) after 50 cycles: Capacity maintenance rate (vs. LMO) after 50 cycles is evaluation of the life (cycle durability) using a full cell. To evaluate the life (cycle durability) as a lithium secondary battery, a full cell was manufactured by using each of the Negative electrode material Examples 1-I to 4-III and the negative electrode material Comparative Examples 5-I to 7-III into a negative electrode, and lithium manganate was used as a positive electrode.

As an electrolytic solution, a solution dissolved LiPF₆ in 1 mol/L into a mixed solvent consist of ethylene carbonate and diethyl carbonate in 1:1 in volume and externally added vinylidene carbonate in 2% by volume was used. As a separator, a porous polypropylene film of 20 μm-thick was used.

The capacity maintenance rate after charging/discharging of the full cell 50-cycles was measured. The capacity maintenance rate after charging/discharging of 50-cycles was calculated by measuring a discharge capacity at the 50th cycle, and dividing the measured value by a discharge capacity at the fifth cycle and multiplying the quotient by 100. The charging condition in the life evaluation using the full cell was as follows. In the first cycle charging, the full cell was charged under a constant current and constant voltage (CCCV) condition with charge ratio of 0.05 C until end voltage reach to 4.2 V. Then the full cell was discharged in the first cycle discharging under a constant current (CC) condition at discharging rate of 0.05 C until end voltage reach to 3.0 V. In the second to fourth cycle charging, the full cell was charged under a constant current and constant voltage (CCCV) condition at a charge ratio of 0.1 C until end voltage reach to 4.2 V. Then, the full cell was discharged under a constant current (CC) condition at discharging rate of 0.1 C until end voltage reach to 3.0 V. The fifth cycle charging/discharging and the rest until the 50th cycle charging/discharging were carried out under the same condition except for setting both the charging rate and the discharging rate of 0.5 C.

### Comparison Among Examples and Comparative Examples

Determination results are summarized in Table 2. Table 2 shows the results in order of values of (Ra/D₅₀(c)) indicating a relation between the surface roughness (Ra) of an electro-deposited copper foil and the average particle size (D₅₀(c)) of an active substance, and in the order of Comparative Example 1, Examples 1 to 4 and Comparative Example 2.

TABLE 2

| | | | Comparative | Example | | | | Comparative | Comparative |
|---|---|---|---|---|---|---|---|---|---|
| Item | | | Example 1 | Example 1 | Example 2 | Example 3 | Example 4 | Example 2 | Example 3 |
| Electro- | Kind | | electro-deposited copper foil | | | | | | |
| Deposited | | | E | A | B | C | D | F | G |
| Copper | Surface Roughness of | | 0.19 | 0.21 | 0.31 | 0.32 | 0.42 | 0.60 | 0.21 |
| Foil used | Electro-Deposited | | | | | | | | |
| as | Copper Foil Ra/[μm] | | | | | | | | |
| Negative | Average Particle | | — | 0.25 | — | 0.70 | 0.88 | 1.30 | 0.25 |
| Electrode | size of Roughening | | | | | | | | |
| Current | Fine Particles D(p) | | | | | | | | |
| Collector | Relation | D₅₀(c) | — | 0.13 | — | 0.35 | 0.44 | 0.65 | 0.13 |
| | between D(p) | 2.0 μm | | | | | | | |
| | and D₅₀(c)* | D₅₀(c) | — | 0.10 | — | 0.27 | 0.34 | 0.50 | 0.10 |
| | [D(p)/D₅₀(c)] | 2.6 μm | | | | | | | |
| | | D₅₀(c) | — | 0.06 | — | 0.18 | 0.22 | 0.33 | 0.06 |
| | | 4.0 μm | | | | | | | |

| | Present/absent of | Present | | | | | | | | | | | | Absent | |
|---|---|---|---|---|---|---|---|---|---|---|---|---|---|---|---|
| | Silane Coupling | | | | | | | | | | | | | | |
| | Agent Treatment | | | | | | | | | | | | | | |
| Average | Relation between Ra | negative | 0.95 | Negative | 0.105 | Negative | 0.155 | Negative | 0.160 | Negative | 0.210 | negative | 0.300 | negative | 0.105 |
| Particle | and D₅₀(c) | electrode | | electrode | | electrode | | electrode | | electrode | | electrode | | electrode | |
| size of | (Ra/[D₅₀(c)])** | material | | material | | material | | material | | material | | material | | material | |
| Active | First Cycle | Comparative | 79 | Example 1-I | 80 | Example 2-I | 80 | Example 3-I | 79 | Example 4-I | 75 | Comparative | 68 | Comparative | 74 |
| Substance | Charging/discharging | Example 5-I | | | | | | | | | | Example 6-I | | Example 7-I | |
| D₅₀(c) | Efficiency (vs. Li) | | | | | | | | | | | | | | |
| 2.0 μm | [%] | | | | | | | | | | | | | | |
| | Capacity Maintenance | | 73 | | 85 | | 82 | | 78 | | 74 | | 53 | | 78 |
| | rate after 50 Cycles | | | | | | | | | | | | | | |
| | (vs. LMO) [%] | | | | | | | | | | | | | | |
| Average | Relation between Ra | negative | 0.073 | Negative | 0.081 | Negative | 0.199 | Negative | 0.123 | Negative | 0.162 | negative | 0.231 | negative | 0.081 |
| Particle | and D₅₀(c) | electrode | | electrode | | electrode | | electrode | | electrode | | electrode | | electrode | |
| size of | (Ra/[D₅₀(c)])** | material | | material | | material | | material | | material | | material | | material | |
| Active | First Cycle | Comparative | 78 | Example | 78 | Example | 89 | Example | 85 | Example | 78 | Comparative | 75 | Comparative | 74 |
| Substance | Charging/discharging | Example 5-II | | 1-II | | 2-II | | 3-II | | 4-II | | Example 6-II | | Example 7-II | |
| D₅₀(c) | Efficiency (vs. Li) | | | | | | | | | | | | | | |
| 2.6 μm | [%] | | | | | | | | | | | | | | |
| | Capacity Maintenance | | 74 | | 86 | | 91 | | 88 | | 86 | | 66 | | 79 |
| | rate after 50 Cycles | | | | | | | | | | | | | | |
| | (vs. LMO) [%] | | | | | | | | | | | | | | |
| Average | Relation between Ra | negative | 0.048 | Negative | 0.053 | Negative | 0.078 | Negative | 0.080 | Negative | 0.105 | negative | 0.150 | negative | 0.053 |
| Particle | and D₅₀(c) | electrode | | electrode | | electrode | | electrode | | electrode | | electrode | | electrode | |
| size of | (Ra/[D₅₀(c)])** | material | | material | | material | | material | | material | | material | | material | |
| Active | First Cycle | Comparative | 69 | Example | 78 | Example | 82 | Example | 80 | Example | 80 | Comparative | 75 | Comparative | 73 |
| Substance | Charging/discharging | Example 5- | | 1-III | | 2-III | | 3-III | | 4-III | | Example 6- | | Example 7- | |
| D₅₀(c) | Efficiency (vs. Li) | III | | | | | | | | | | III | | III | |
| 4.0 μm | [%] | | | | | | | | | | | | | | |
| | Capacity Maintenance | | 64 | | 70 | | 82 | | 80 | | 85 | | 73 | | 66 |
| | rate after 50 Cycles | | | | | | | | | | | | | | |
| | (vs. LMO) [%] | | | | | | | | | | | | | | |

| | | | | | | | |
|---|---|---|---|---|---|---|---|
| Comprehensive Determination | D | C | A | B | C | D | D |

*The average particle size D(p) is preferably [0.06 × D₅₀(c)] μm to [0.44 × D₅₀(c)] μm.
**The surface roughness (Ra) of a negative electrode current collector is preferable to be [0.053 × D₅₀(c)] μm to [0.210 × D₅₀(c)] μm.

Table 2 shows the matters described below. Then, the results will be described one by one along the average particle size (D₅₀(c)) of an active substance.

If the average particle size (D₅₀(c)) of an active substance is 2.0 μm, Examples 1 to 4 in which (Ra/D₅₀(c)) are 0.105 to 0.210 achieve “the first cycle charging/discharging efficiency (vs. Li)” of 75% to 80%, but Comparative Example 2 achieves a first cycle charging/discharging efficiency of only just 68%. With regard to “the capacity maintenance rate (vs. LMO) after 50 cycles”, Examples 1 to 4 in which (Ra/D₅₀(c)) are 0.105 to 0.210 achieve capacity maintenance rates of 74% to 85%, but Comparative Example 2 achieves a capacity maintenance rate after 50 cycles of only just 53%. In contrast, in Comparative Example 1 in which the average particle size (D₅₀(c)) of an active substance is 2.0 μm shows rather good performance, a first cycle charging/discharging efficiency of 79% and a capacity maintenance rate after 50 cycles of 73%. According to comparison between Comparative Example 3 without silane coupling agent treatment layer and Example 1, if the average particle size (D₅₀(c)) of an active substance is 2.0 μm, the case without silane coupling agent treatment layer exhibits a first cycle charging/discharging efficiency of 74%, and a capacity maintenance rate after 50 cycles of 78%. In contrast, the case without silane coupling agent treatment layer achieves a first cycle charging/discharging efficiency of 80%, and a capacity maintenance rate after 50 cycles of 85%. These matters show that a copper foil provided with a silane coupling agent treatment layer is more suitable as a negative electrode current collector for a lithium ion secondary battery.

If the average particle size (D₅₀(c)) of an active substance is 2.6 μm, Examples 1 to 4 in which (Ra/D₅₀(c)) are 0.081 to 0.162 in the measurements of “the first cycle charging/discharging efficiency (vs. Li)” achieve first cycle charging/discharging efficiencies of 78% to 89%, but Comparative Example 2 achieves a first cycle charging/discharging efficiency of only just 75%. Then, Examples 1 to 4 in which (Ra/D₅₀(c)) are 0.081 to 0.162 achieve capacity maintenance rates after 50 cycles of 86% to 91% in the measurement of “the capacity maintenance rate (vs. LMO) after 50 cycles”, but Comparative Example 2 achieves a capacity maintenance rate after 50 cycles of only just 66%. In contrast, Comparative Example 1 in which the average particle size (D₅₀(c)) of an active substance is 2.6 μm achieves a first cycle charging/discharging efficiency of 78% and a capacity maintenance rate after 50 cycles of 74%. These results are inferior to Example 1 to Example 4, but rather good. According to comparison between Comparative Example 3 without silane coupling agent treatment layer and Example 1, if the average particle size (D₅₀(c)) of an active substance is 2.6 μm, the case without silane coupling agent treatment layer achieves a first cycle charging/discharging efficiency of 74%, and a capacity maintenance rate after 50 cycles of 79%. In contrast, the case with a silane coupling agent treatment layer achieves a first cycle charging/discharging efficiency of 78%, and a capacity maintenance rate after 50 cycles of 86%. These matters show that a copper foil provided with a silane coupling agent treatment layer is more suitable as a negative electrode current collector for a lithium ion secondary battery.

If the average particle size (D₅₀(c)) of an active substance was 4.0 μm, Examples 1 to 4 in which (Ra/D₅₀(c)) are 0.053 to 0.105 achieve first cycle charging/discharging efficiencies of 78% to 82% in the measurement of “the first cycle charging/discharging efficiency (vs. Li)”, but Comparative Example 1 achieves a first cycle charging/discharging efficiency of only just 69%, and Comparative Example 2 achieves a first cycle charging/discharging efficiency of only just 75%. Then, Examples 1 to 4 in which (Ra/D₅₀(c)) are 0.053 to 0.105 achieve capacity maintenance rates after 50 cycles of 70% to 85% in the measurement of “the capacity maintenance rate (vs. LMO) after 50 cycles”, but Comparative Example 1 achieves only just 64%. According to comparison between Comparative Example 3 without silane coupling agent treatment layer and Example 1, if the average particle size (D₅₀(c)) of an active substance is 4.0 μm, the case without silane coupling agent treatment layer achieves a first cycle charging/discharging efficiency of only just 73%, and a capacity maintenance rate after 50 cycles of only just 66%. In contrast, the case with a silane coupling agent treatment layer achieve a first cycle charging/discharging efficiency of 78%, and a capacity maintenance rate after 50 cycles of 70%. These matters show that a copper foil provided with a silane coupling agent treatment layer is more suitable as a negative electrode current collector for a lithium ion secondary battery.

According to the synthetic results described above shown in Table 2, Comparative Examples 1 to 3 are “Not Good”, and Examples 1 to 4 are “Acceptable to Excellent”

### INDUSTRIAL APPLICABILITY

Employing of the above-mentioned technical concept according to the present application enables design of a negative electrode current collector which secures both the charging/discharging capacity and the good charging/discharging cycle property stably without deviation in the properties. Therefore, a copper foil for a negative electrode current collector for a lithium ion secondary battery and a negative electrode material of the lithium ion secondary battery excellent in the long-term usage stability can be provided.

1. A manufacturing method of a negative electrode material for a lithium ion secondary battery provided with a negative electrode mixture layer including a negative electrode active substance on a surface of a negative electrode current collector, comprising:
one or mixture selected from granular materials alloyable with lithium and carbon materials for storing and releasing lithium is used as the negative electrode active substance characterized in
an electro-deposited copper foil in which a surface roughness (Ra) is 0.20 μm<Ra<0.50 μm and the surface roughness (Ra) satisfies [0.053×D₅₀(c)] μm to [0.210×D₅₀(c)] μm where (D₅₀(c)) is an average particle size of the negative electrode active substance is selectively used as the negative electrode current collector;
a silane coupling agent treatment layer is provided on a surface of the electro-deposited copper foil; and
the negative electrode material is finished by providing the negative electrode active substance on a surface of the silane coupling agent treatment layer.

2. The manufacturing method of a negative electrode material for a lithium ion secondary battery according to claim 1, wherein the electro-deposited copper foil has a roughened surface with fine metal particles attached having an average particle size (D(p)) of [0.06×D₅₀(c)] μm to [0.44×D₅₀(c)] μm where (D₅₀(c)) is an average particle size of the negative electrode active substance on one surface or both surfaces of the copper foil.

3. The manufacturing method of a negative electrode material for a lithium ion secondary battery according to claim 1, wherein the electro-deposited copper foil has a roughened surface with fine metal particles attached composed of any one selected from copper, a copper alloy, nickel, a nickel alloy, cobalt and a cobalt alloy.

4. The manufacturing method of a negative electrode material for a lithium ion secondary battery according to claim 1, wherein an average particle size (D₅₀(c)) of the negative electrode active substance is 2.0 μm to 4.0 μm.

5. The manufacturing method of a negative electrode material for a lithium ion secondary battery according to claim 1, wherein the negative electrode active substance includes tin or silicon as a material alloyable with lithium.

6. A negative electrode material for a lithium ion secondary battery, characterized in manufactured by the manufacturing method of a negative electrode material for a lithium ion secondary battery according to claim 1.
